(19) United States
(12) Patent Application Publication
(10) Pub. No.: US 2010/0164743 A1
(43) Pub. Date: Jul. 1, 2010

(54) OPERATING SIGNAL SYSTEM AND METHOD FOR CONTROLLING A MOTORIZED WINDOW COVERING

(75) Inventors: Douglas R. Domel, Santa Clarita, CA (US); Winston G. Walker, Littleton, CO (US)

Correspondence Address: PROCOPIO, CORY, HARGREAVES & SAVITCH LLP, 525 B STREET, SUITE 2200, SAN DIEGO, CA, 92101, US

(73) Assignee: Harmonic Design, Inc., Poway, CA (US)

(21) Appl. No.: 12/688,795

(22) Filed: Jan. 15, 2010

Related U.S. Application Data
(63) Continuation of application No. 10/062,655, filed on Feb. 1, 2002, now abandoned.

(51) Int. Cl. G08C 19/00

(52) U.S. Cl. 340/825.57

(57) ABSTRACT

A motorized window covering includes a motor and a housing that holds the motor and a dc battery. Also, within the housing is a wake-up signal amplifier that is constantly energized and a data signal amplifier that is only energized when a wake-up signal is received. A remote control unit is used to generate and transmit the wake-up signal and a data signal that is use to control the operation of the window covering.

### RELATED APPLICATIONS

This application claims the benefit of copending U.S. patent application Ser. No. 10/062,655, filed Feb. 2, 2002, entitled “OPERATING SIGNAL SYSTEM AND METHOD FOR CONTROLLING A MOTORIZED WINDOW COVERING,” which is hereby incorporated by reference in its entirety.

### BACKGROUND

1. Field of the Invention

The present invention relates generally to window covering peripherals and more particularly to remotely-controlled window covering actuators.

2. Background of the Invention

Window coverings that can be opened and closed are used in a vast number of business buildings and dwellings. Examples of such coverings include horizontal blinds, vertical blinds, pleated shades, roll-up shades, and cellular shades made by, e.g., Spring Industries®, Hunter-Douglas®, and Levellor®.

The present assignee has provided several systems for either lowering or raising a window covering, or for moving the slats of a window covering between open and closed positions. Such systems are disclosed in U.S. Pat. Nos. 6,189,592, 5,495,153, and 5,907,227, incorporated herein by reference. These systems include a motor driven gear box that is coupled to a tilt rod of the window covering. When the motor is energized, the tilt rod rotates clockwise or counterclockwise. These systems can be, e.g., operated via a remote control unit. Typically, these remotely operated systems include a transmitter in the remote control unit and a receiver in an actuator that is mechanically coupled to the blinds. In most cases, the receiver remains awake constantly or pulses between on and off. Thus, when a signal is sent by the transmitter, the receiver can receive it, but in the case of pulsed receivers, only when the receiver is in the “on” state. Unfortunately, the receiver can require a relatively high amount of current in order to properly operate. As a result, if the receiver is powered by a direct current power source such as a battery it can quickly drain the battery. On the other hand, continuously pulsing the receiver between power on and power off can help increase battery life, but the battery still can relatively quickly lose power, since the duty cycle between “off” and “on” must be relatively short, to avoid missing a user signal.

Accordingly, the present invention recognizes a need for a control system for a motorized window covering that further conserves powers.

### SUMMARY

A motorized window covering includes a remote control unit having a transmitter installed therein. An actuator is coupled to the window covering and has a receiver installed therein. The receiver receives a signal from the transmitter. Moreover, a wake-up signal amplifier and a data signal amplifier are electrically connected to the receiver.

In a preferred embodiment, a wake-up signal is transmitted by the transmitter and received by the receiver. Moreover, a data signal is transmitted by the transmitter and received by the receiver. Preferably, the wake-up signal amplifier is energized continuously, i.e., it is always active, and the data-signal amplifier is de-energized until the wake up signal is received at the receiver. Also in a preferred embodiment, the data-signal amplifier is de-energized if the data signal is not received at the receiver within a predetermined time period.

In another aspect of the present invention, a method for controlling a motorized window covering includes deactivating a data signal amplifier. On the other hand, a wake-up signal amplifier is activated. The data signal amplifier is only activated in response to a wake-up signal being received by the wake-up signal amplifier.

In still another aspect of the present invention, a system for controlling a motorized window covering includes an actuator that is mechanically coupled to an operator of the window covering. A receiver is disposed within the actuator and a wakeup signal amplifier and data signal amplifier are electrically connected to the receiver. The actuator may include a microprocessor that has a program for controlling the window covering in response to a wake-up signal and a data signal being received by the receiver.

The details of the present invention, both as to its construction and operation, can best be understood in reference to the accompanying drawings, in which like numerals refer to like parts, and which:

### BRIEF DESCRIPTION OF THE DRAWINGS

FIG. 1 is a perspective view of a window covering actuator of the present invention, shown in one intended environment, with portions of the head rail cut away for clarity;

FIG. 2 is a perspective view of the gear assembly of the actuator of the present invention, with portions broken away;

FIG. 3A is a perspective view of the main reduction gear of the actuator of the present invention;

FIG. 3B is a cross-sectional view of the main reduction gear of the actuator of the present invention, as seen along the line 3B-3B in FIG. 3A;

FIG. 4 is a schematic of a remote control system; and

FIG. 5 is a flowchart of the logic of the present invention.

### DETAILED DESCRIPTION OF THE PREFERRED EMBODIMENT

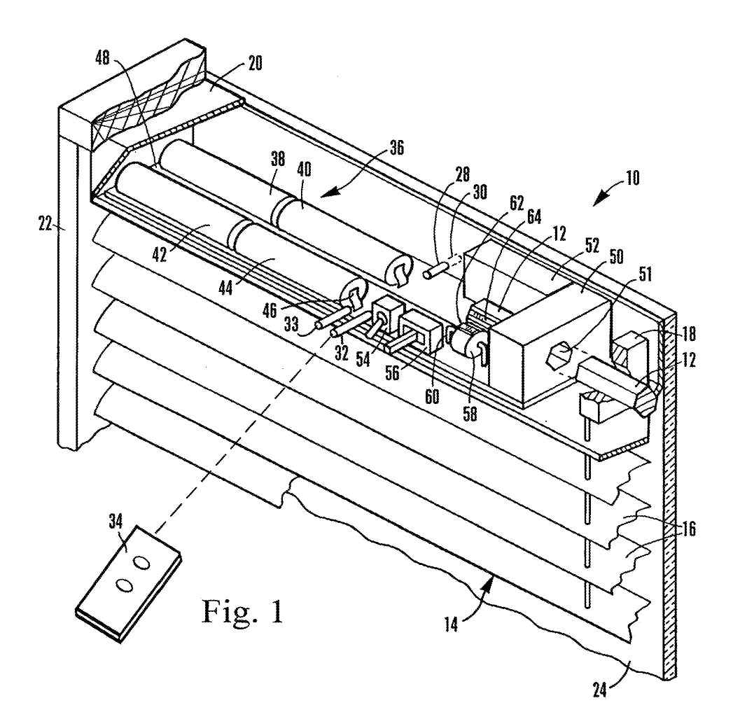

Referring initially to FIG. 1, an actuator is shown, generally designated 10. As shown, the actuator 10 is in operable engagement with a rotatable tilt rod 12 of a window covering, such as but not limited to a horizontal blind 14 having a plurality of louvered slats 16. As shown, the tilt rod 12 is rotatably mounted by means of a block 18 in a head rail 20 of the blind 14.

In the embodiment shown, the blind 14 is mounted on a window frame 22 to cover a window 24, and the tilt rod 12 is rotatable about its longitudinal axis. The tilt rod 12 engages a baton (not shown), and when the tilt rod 12 is rotated about its longitudinal axis, the baton (not shown) rotates about its longitudinal axis and each of the slats 16 is caused to rotate about its respective longitudinal axis to move the blind 14 between an open configuration, wherein a light passageway is established between each pair of adjacent slats, and a closed configuration, wherein no light passageways are established between adjacent slats.

While the embodiment described above discusses a horizontal blind, it is to be understood that the principles of the present invention apply to a wide range of window coverings including, but not limited to the following: vertical blinds, fold-up pleated shades, roll-up shades, cellular shades, skylight covers, and any type of blinds that utilize vertical or horizontal louvered slats.

A control signal generator, preferably a daylight sensor 28, is mounted within the actuator 10 by means well-known in the art, e.g., solvent bonding. In accordance with the present invention, the daylight sensor 28 is in light communication with a light hole 30 through the back of the head rail 20, shown in phantom in FIG. 1. Also, the sensor 28 is electrically connected to electronic components within the actuator 10 to send a control signal to the components, as more fully disclosed below. Consequently, with the arrangement shown, the daylight sensor 28 can detect light that propagates through the window 24, independent of whether the blind 14 is in the open configuration or the closed configuration.

Further, the actuator 10 can include other control signal generators, preferably a first signal sensor 32 and a second signal. sensor 33, for receiving a preferably optical user command signals. Preferably, the user command signals are generated by a handheld user command signal generator 34, which can be an infrared (IR) remote-control unit.

Like the daylight sensor 28, the signal sensors 32, 33 are electrically connected to electronic components within the actuator 10. As discussed in greater detail below, any of the sensors 28; 32, 33 can generate an electrical control signal to activate the actuator 10 and thereby cause the blind 14 to move toward the open or closed configuration, as appropriate.

Preferably, the daylight sensor 28 is a light detector which has low dark currents, to conserve power when the actuator 10 is deactivated. More particularly, the sensor 28 has a dark current equal to or less than about 10⁻⁸ amperes and preferably equal to or less than about 2×10⁻⁹ amperes.

As shown in FIG. 1, a power supply 36 is mounted within the head rail 20. In the preferred embodiment, the power supply 36 includes four or six or other number of type AA direct current (dc) alkaline or Lithium batteries 38, 40, 42, 44. Or, the batteries can be nine volt “transistor” batteries. The batteries 38, 40, 42, 44 are mounted in the head rail 20 in electrical series with each other by means well-known in the art. For example, in the embodiment shown, two pairs of the batteries 38, 40, 42, 44 are positioned between respective positive arid negative metal clips 46 to hold the batteries 38, 40, 42, 44 within the head rail 20 and to establish an electrical path between the batteries 38, 40, 42, 44 and their respective clips.

FIG. 1 further shows that an electronic circuit board 48 is positioned in the head rail 20 beneath the batteries 38, 40, 42, 44. It can be appreciated that the circuit board 48 can be fastened to the head rail 20, e.g., by screws (not shown) or other well-known method and the batteries can be mounted on the circuit board 48. It is to be understood that an electrical path is established between the battery clips 46 and the electronic circuit board 48. Consequently, the batteries 38, 40, 42, 44 are electrically connected to the electronic circuit board 48. Further, it is to be appreciated that the electronic circuit board 48 may include a microprocessor.

Still referring to FIG. 1, a lightweight metal or molded plastic gear box 50 is mounted preferably on the circuit board 48. The gear box 50 can be formed with a channel 51 sized and shaped for receiving the tilt rod 12 therein. As can be appreciated in reference to FIG. 1, the tilt rod 12 has a hexagonally-shaped transverse cross-section, and the tilt rod 12 is slidably engageable with the gear box opening 51. Accordingly, the actuator 10 can be slidably engaged with the tilt rod 12 substantially anywhere along the length of the tilt rod 12.

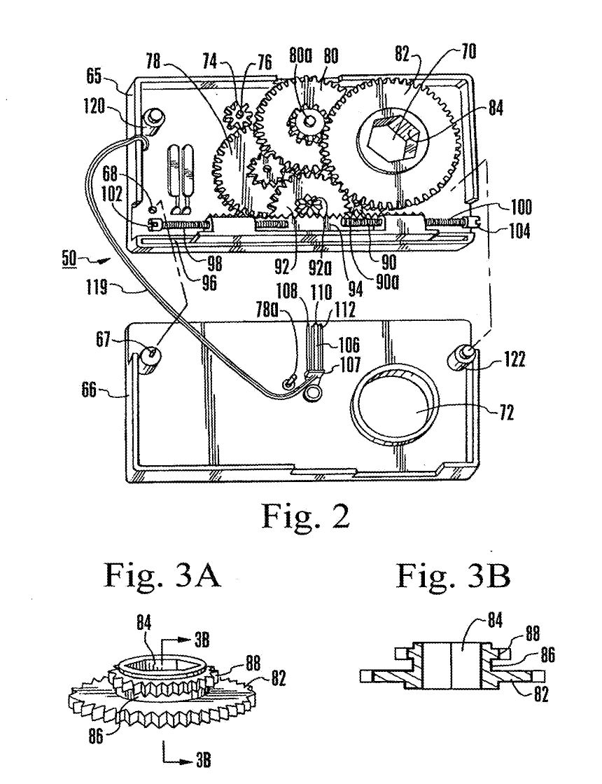

FIG. 1 also shows that a small, lightweight electric motor 52 is attached to the gear box 50, preferably by bolting the motor 52 to the gear box 50. As more fully disclosed in reference to FIG. 2 below, the gear box 50 holds a gear assembly which causes the tilt rod 12 to rotate at a fraction of the angular velocity of the motor 52. Preferably, the motor 52 can be energized by the power supply 36 through the electronic circuitry of the circuit board 48 and can be mounted on the circuit board 48.

Also, in a non-limiting embodiment, a manually manipulable operating switch 54 can be electrically connected to the circuit board 48. The switch 54 shown in FIG. 1 is a two-position on/off power switch used to turn the power supply on and off. Further, a three-position mode switch 56 is electrically connected to the circuit board 48. The switch 56 has an “off” position, wherein the daylight sensor 28 is not enabled, a “day open” position, wherein the blind 14 will be opened by the actuator 10 in response to daylight impinging on the sensor 28, and a “day shut” position, wherein the blind 14 will be shut by the actuator 10 in response to daylight impinging on the sensor 28.

FIG. 1 further shows that in another non-limiting embodiment, a manually manipulable adjuster 58 can be rotatably mounted on the circuit board 48 by means of a bracket 60. The periphery of the adjuster 58 extends beyond the head rail 20, so that a person can turn the adjuster 58.

As intended by the present invention, the adjuster 58 can have a metal strip 62 attached thereto, and the strip 62 on the adjuster 58 can contact a metal tongue 64 which is mounted on the tilt rod 12 when the tilt rod 12 has rotated in the open direction. When the strip 62 contacts the tongue 64, electrical contact is made there between to signal an electrical circuit on the circuit board 48 to de-energize the motor 52. Accordingly, the adjuster 58 can be rotationally positioned as appropriate such that the strip 62 contacts the tongue 64 at a predetermined angular position of the tilt rod 12. Stated differently, the tilt rod 12 has a closed position, wherein the blind 14 is fully closed, and an open position, wherein the blind 14 is open, and the open position is selectively established by manipulating the adjuster 58.

Now referring to FIGS. 2, 3A, and 3B, the details of the gear box 50 can be seen. As shown best in FIG. 2, the gear box 50 includes a plurality of lightweight metal or molded plastic gears, i.e., a gear assembly, and each gear can be rotatably mounted within the gear box 50. In the presently preferred embodiment, the gear box 50 is a clamshell structure which includes a first half 65 and a second half 66, and the halves 65, 66 of the gear box 50 are snappingly engageable together by means well-known in the art. For example, in the embodiment shown, a post 67 in the second half 66 of the gear box 50 engages a hole 68 in the first half 65 of the gear box 50 in an interference fit to hold the halves 65, 66 together.

Each half 62, 64 includes a respective opening 70, 72, and the openings 70, 72 of the gear box 50 are coaxial with the gear box channel 51 (FIG. 1) for slidably receiving the tilt rod 12 therethrough.

As shown in FIG. 2, a motor gear 74 is connected to the rotor 76 of the motor 60. In turn, the motor gear 74 is engaged with a first reduction gear 78, and the first reduction gear 78 is engaged with a second reduction gear 80. In turn, the second reduction gear 80 is engaged with a main reduction gear 82. To closely receive the hexagonally-shaped tilt rod 12, the main reduction gear 82 has a hexagonally-shaped channel 84. As intended by the present invention, the channel 84 of the main reduction gear 82 is coaxial with the openings 70, 72 (and, thus, with the gear box channel 51 shown in FIG. 1).

It can be appreciated in reference to FIG. 2 that when the main reduction gear 82 is rotated, and the tilt rod 12 is engaged with the channel 84 of the main reduction gear 82, the sides of the channel 84 contact the tilt rod 12 to prevent rotational relative motion between the tilt rod 12 and the main reduction gear 82. Further, the reduction gears 78, 80, 82 cause the tilt rod 12 to rotate at a fraction of the angular velocity of the motor 60. Preferably, the reduction gears 78, 80, 82 reduce the angular velocity of the motor 60 such that the tilt rod 12 rotates at about one revolution per second. It can be appreciated that greater or fewer gears than shown can be used.

It is to be understood that the channel 84 of the main reduction gear 82 can have other shapes suitable for conforming to the shape of the particular tilt rod being used. For example, for a tilt rod (not shown) having a circular transverse cross-sectional shapes, the channel 84 will have a circular cross-section. In such an embodiment, a set screw (not shown) is threadably engaged with the main reduction gear 82 for extending into the channel 84 to abut the tilt rod and hold the tilt rod stationary within the channel 84. In other words, the gears 74, 78, 80, 82 described above establish a coupling which operably engages the motor 60 with the tilt rod 12.

In continued cross-reference to FIGS. 2, 3A, and 3B, the main reduction gear 82 is formed on a hollow shaft 86, and the shaft 86 is closely received within the opening 70 of the first half 62 of the gear box 50 for rotatable motion therein. Also, in a nonlimiting embodiment, a first travel limit reduction gear 88 is formed on the shaft 86 of the main reduction gear 82. The first travel limit reduction gear 88 is engaged with a second travel limit reduction gear 90, and the second travel limit reduction gear 90 is in turn engaged with a third travel limit reduction gear 92.

FIG. 2 best shows that the third travel limit reduction gear 92 is engaged with a linear rack gear 94. Thus, the main reduction gear 82 is coupled to the rack gear 94 through the travel limit reduction gears 88, 90, 92, and the rotational speed (i.e., angular velocity) of the main reduction gear 82 is reduced through the first, second, and third travel limit reduction gears 88, 90, 92. Also, the rotational motion of the main reduction gear 82 is translated into linear motion by the operation of the third travel limit reduction gear 92 and rack gear 94.

FIG. 2 also shows that in non-limiting embodiments, the second reduction gear 80 and second and third travel limit reduction gears 90, 92 can be rotatably engaged with respective metal post axles 80a, 90a, 92a which are anchored in the first half 65 of the gear box 50. In contrast, the first reduction gear 78 is rotatably engaged with a metal post axle 78a which is anchored in the second half 66 of the gear box 50.

Still referring to FIG. 2, the rack gear 94 can be slidably engaged with a groove 96 that is formed in the first half 65 of the gear box 50. First and second travel limiters 98, 100 can be connected to the rack gear 94. In the non-limiting embodiment shown, the travel limiters 98, 100 are threaded, and are threadably engaged with the rack gear 94. Alternatively, travel limiters (not shown) having smooth surfaces may be slidably engaged with the rack gear 94 in an interference fit therewith, and may be manually moved relative to the rack gear 94.

As yet another alternative, travel limiters (not shown) may be provided which are formed with respective detents (not shown). In such an embodiment, the rack gear is formed with a channel having a series of openings for receiving the detents, and the travel limiters can be manipulated to engage their detents with a preselected pair of the openings in the rack gear channel. In any case, it will be appreciated that the position of the travel limiters of the present invention relative to the rack gear 94 may be manually adjusted.

FIG. 2 shows that in one non-limiting embodiment, each travel limiter 98, 100 has a respective abutment surface 102, 104. As shown, the abutment surfaces 102, 104 can contact a switch 106 which is mounted on a base 107. The base 107 is in turn anchored on the second half 66 of the gear box 50. As intended by the present invention, the switch 106 includes electrically conductive first and second spring arms 108, 112 and an electrically conductive center arm 110. As shown, one end of each spring arm 108, 112 is attached to the base 107, and the opposite ends of the spring. arms 108, 112 can move relative to the base 107. As also shown, one end of the center arm 110 is attached to the base 107.

When the main reduction gear 82 has rotated sufficiently counterclockwise, the abutment surface 102 of the first travel limiter 98 contacts the first spring arm 108 of the switch 106 to urge the first spring arm 108 against the stationary center arm 110 of the switch 106. On the other hand, when the main reduction gear 82 has rotated clockwise a sufficient amount, the abutment surface 104 of the second travel limiter 100 contacts the second spring arm 112 of the switch 106 to urge the second spring arm 112 against the stationary center arm 110 of the switch 106.

It can be appreciated in reference to FIG. 2 that the switch 106 can be electrically connected to the circuit board 52 (FIG. 1) via an electrical lead 119. Moreover, the first spring arm 108 can be urged against the center arm 110 to complete one branch of the electrical circuit on the circuit board 48. On the other hand, the second spring arm 112 can be urged against the center arm 110 to complete another branch of the electrical circuit on the circuit board 48.

The completion of either one of the electrical circuits discussed above causes the motor 52 to de-energize and consequently stops the rotation of the main reduction gear 82 and, hence, the rotation of the tilt rod 12. Stated differently, the travel limiters 98, 100 may be manually adjusted relative to the rack gear 94 as appropriate for limiting the rotation of the tilt rod 12 by the actuator 10.

Referring briefly back to FIG. 2, spacers 120, 122 may be molded onto the halves 62, 64 for structural stability when the halves 62, 64 of the gear box 56 are snapped together.

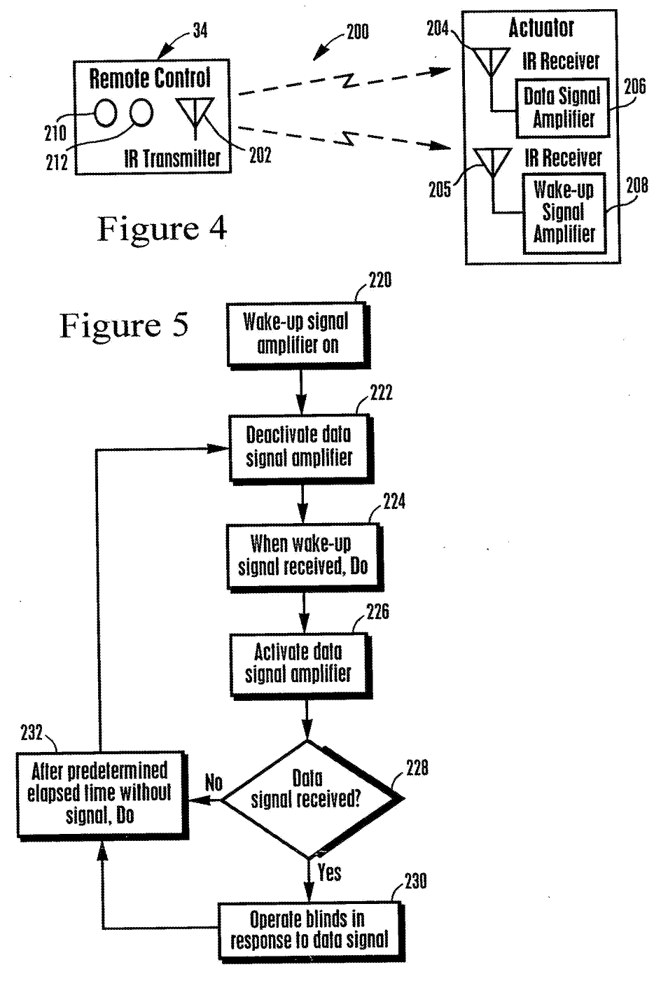

Referring now to FIG. 4, a remote control system for the actuator 10 is shown and generally designated 200. FIG. 4 shows that the remote control system 200 includes the remote control unit 34 described below. Preferably, the remote control unit 34 includes an IR transmitter 202. While IR is preferred, radio frequency (RF) or other means of communication can be used. Moreover, the actuator 10 includes a data signal IR receiver 204 and a wake-up signal IR receiver 205. In accordance with the present invention the IR transmitter 202 sends multiple signals, described below, that can be received by the data signal IR receiver 204 or the wake-up signal IR receiver 205 within the actuator 10.

As shown in FIG. 4, the data signal IR receiver 204 can be connected to a data signal amplifier 206 and the wake-up signal IR receiver 205 can be connected to a wake-up signal amplifier 208. The data signal amplifier 206 recognizes a data signal and the wake-up signal amplifier 208 recognizes a wake-up signal. In a preferred embodiment, the data signal has an operating frequency that is different from the wake-up signal operating frequency. For example, the data signal, when IR, can have a frequency of 38 kiloHertz (kHz) and the wake-up signal, when IR, can have a frequency of 475 Hertz (Hz).

As intended by the present invention, the frequency of the wake-up signal must be low enough so that the wake-up signal amplifier 208, which is always on, does not rapidly dissipate the power supply 36. On the other hand, the higher frequency of the data signal is dictated by the desire to transmit the control data fast enough to obtain a prompt response with signal verification at the data signal IR receiver 204- and this generally involves receiving more than a single code.

Referring still to FIG. 4, the remote control unit 34 includes an “Up” button 210 and a “Down” button 212. It is to be understood that the remote control unit 34 can have other buttons, e.g., “Rotate,” “Tilt,” etc. When either button 210, 212 is pressed, the wake-up signal is automatically generated as a precursor to the data signal.

FIG. 5 shows the operating logic of the present invention which commences at block 220 wherein the wake-up signal amplifier 208 is on either continuously or less preferably, as part of an “on” state portion of an off-and-on duty cycle. Conversely, at block 222, the data signal amplifier 206 is deactivated’. Moving to block 224, a do loop is entered wherein when a wake-up signal is received, the following steps are performed. Specifically, when the wake-up signal is received, the logic proceeds to block 226 and the data signal amplifier 206 is activated. Next, at decision diamond 228, it is determined whether a data signal is received. If so, the logic continues to block 230 where the blinds are operated in response to the data signal. The data signal can include commands that cause the blinds 14, e.g., to tilt open, tilt close, roll open, roll close, etc.

If at decision diamond 228 a data signal is not received, the logic moves to block 232 where after a predetermined elapsed time without a data signal, the logic returns to block 222 where the data signal amplifier 206 is again deactivated. In accordance with the principles of the present invention, the wake-up signal amplifier 208, which consumes very little power, is always on. On the other hand, the data signal amplifier 206 is turned off when not in use to reduce its power consumption which is markedly greater than that of the wake-up signal amplifier 208. Accordingly, the data signal amplifier 206 is deactivated, when not in use, so that it will not quickly consume battery power. As a result, the battery has a relatively longer life.

While the particular OPERATING SIGNAL SYSTEM AND METHOD FOR CONTROLLING A MOTORIZED WINDOW COVERING as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

What is claimed is:

1. A motorized window co ring, comprising:
a remote control unit;
a transmitter within the remote control unit;
an actuator coupled to the window covering;
a receiver within the actuator, the receiver receiving at least one signal from the transmitter;
a wake-up signal amplifier electrically connected to the receiver; and
a data signal amplifier electrically connected to the receiver.
